(19) United States
(12) Patent Application Publication
(10) Pub. No.: US 2025/0053855 A1
(43) Pub. Date: Feb. 13, 2025

(54) MACHINE LEARNING BASED UPDATES OF DOMAIN SPECIFIC LANGUAGE PARAMETERS

(71) Applicant: Capital One Services, LLC, McLean, VA (US)

(72) Inventors: Peter M. GHIORSE, New York City, NY (US); Pavel FORT, Westbury, NY (US); Michael HOLDEN, San Jose, CA (US)

(21) Appl. No.: 18/366,273

(22) Filed: Aug. 7, 2023

(51) Int. Cl. G06N 20/00; G10L 15/06; G10L 15/183; G10L 15/22; G10L 15/30

(52) U.S. Cl. CPC G06N 20/00; G10L 15/063; G10L 15/183; G10L 15/22; G10L 15/30; G10L 2015/0635; G10L 2015/088; G10L 2015/228

(57) ABSTRACT

In some implementations, a device may obtain an input indicating information associated with one or more attributes of an entity. The device may analyze the input to identify one or more words or phrases from the input. The device may detect one or more domain specific language (DSL) keywords, from the one or more words or phrases, indicative of one or more brand parameters associated with the entity. The device may provide, to a machine learning model, an indication of the entity and the one or more words or phrases. The device may obtain, via an output of the machine learning model and based on providing the indication of the entity and the one or more words or phrases, an indication of updates to be made for the one or more brand parameters. The device may perform an action based on the output of the machine learning model.

### BACKGROUND

Machine learning is a field associated with building methods that “learn” (e.g., methods that leverage data to improve performance on some set of tasks). Machine learning algorithms build a model based on sample data, sometimes referred to as training data, in order to make predictions or decisions without being explicitly programmed to do so. Once trained, machine learning models may be used to make predictions, decisions, or classifications relating to new observations. Machine learning algorithms are used in a wide variety of applications, such as computer vision, natural language processing, financial applications, medical diagnosis, email filtering, speech recognition, and/or information retrieval, among other examples, where it is difficult or unfeasible to develop conventional algorithms to perform the needed tasks.

### SUMMARY

Some implementations described herein relate to a system for machine learning based updates of domain specific language (DSL) parameters. The system may include one or more memories and one or more processors communicatively coupled to the one or more memories. The one or more processors may be configured to obtain audio data indicating information associated with one or more attributes associated with an entity. The one or more processors may be configured to analyze the audio data to identify one or more words or phrases from the audio data. The one or more processors may be configured to detect one or more keywords, from the one or more words or phrases, indicative of the entity. The one or more processors may be configured to provide, to a machine learning model, an indication of the entity and the one or more words or phrases. The one or more processors may be configured to obtain, from the machine learning model and based on providing the indication of the entity and the one or more words or phrases, an indication of one or more DSL parameters that are to be updated for the entity, wherein the one or more DSL parameters are associated with the one or more attributes. The one or more processors may be configured to update, based on an output of the machine learning model, the one or more DSL parameters to obtain one or more updated DSL parameters.

Some implementations described herein relate to a method of machine learning based updates of brand parameters. The method may include obtaining, by a device, an input indicating information associated with one or more attributes of an entity. The method may include analyzing, by the device, the input to identify one or more words or phrases from the input. The method may include detecting, by the device, one or more DSL keywords, from the one or more words or phrases, indicative of one or more brand parameters associated with the entity. The method may include providing, by the device and to a machine learning model, an indication of the entity and the one or more words or phrases. The method may include obtaining, by the device and via an output of the machine learning model and based on providing the indication of the entity and the one or more words or phrases, an indication of updates to be made for the one or more brand parameters. The method may include performing, by the device, an action based on the output of the machine learning model.

Some implementations described herein relate to a non-transitory computer-readable medium that stores a set of instructions. The set of instructions, when executed by one or more processors of a device, may cause the device to obtain audio data indicating information associated with one or more attributes associated with an entity. The set of instructions, when executed by one or more processors of the device, may cause the device to analyze the audio data to identify one or more words or phrases from the audio data. The set of instructions, when executed by one or more processors of the device, may cause the device to detect one or more keywords, from the one or more words or phrases, indicative of the entity. The set of instructions, when executed by one or more processors of the device, may cause the device to provide, to a machine learning model, an indication of the entity and the one or more words or phrases. The set of instructions, when executed by one or more processors of the device, may cause the device to obtain, from the machine learning model and based on providing the indication of the entity and the one or more words or phrases, an indication of one or more DSL parameters that are to be updated for the entity. The set of instructions, when executed by one or more processors of the device, may cause the device to update, based on an output of the machine learning model, the one or more DSL parameters to obtain one or more updated DSL parameters.

### BRIEF DESCRIPTION OF THE DRAWINGS

FIGS. 1A-1C are diagrams of an example associated with machine learning based updates of domain specific language (DSL) parameters, in accordance with some embodiments of the present disclosure.

FIG. 2 is a diagram illustrating an example of training and using a machine learning model in connection with machine learning based updates of DSL parameters, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with machine learning based updates of DSL parameters, in accordance with some embodiments of the present disclosure.

FIG. 5 is a flowchart of an example process associated with machine learning based updates of DSL parameters, in accordance with some embodiments of the present disclosure.

### DETAILED DESCRIPTION

The following detailed description of example implementations refers to the accompanying drawings. The same reference numbers in different drawings may identify the same or similar elements.

Artificial intelligence describes different ways that a machine interacts with an environment. Through advanced, human-like intelligence (e.g., provided by software and hardware), an artificial intelligence system may perceive an environment and take actions that maximize a chance of achieving goals. Machine learning is an approach, or a subset, of artificial intelligence, with an emphasis on learning rather than just computer programming. A machine learning system may utilize complex models to analyze a massive amount of data, recognize patterns among the data, and generate an output (e.g., a prediction, a classification, and/or a recommendation) without requiring a human to program specific instructions.

In some examples, an application, program, and/or machine learning model may be programmed with parameters or other instructions using a domain specific language (DSL). A DSL may be a programming language specifically designed to address the needs and challenges of a particular domain or problem space. Unlike general-purpose programming languages (such as Java, Python, or C++), which are designed to be versatile and applicable to a wide range of tasks, DSLs may be tailored to a specific domain and offer abstractions and syntax that are intuitive and natural for that particular domain. DSLs may provide a higher level of abstraction, allowing developers to express domain concepts more concisely and accurately. This can lead to faster development, improved readability (e.g., by aligning the language constructs and syntax with the domain, DSLs can make code more readable and easier to understand), and/or improved optimization (e.g., DSLs can be optimized specifically for the problem domain, enabling performance improvements or tailored solutions that may not be achievable with general-purpose languages), among other examples.

However, DSLs may be associated with decreased flexibility and increased barriers for adoption as compared to general purpose languages. For example, DSLs may introduce a new language with its own syntax and semantics. Developers may need to invest time and effort to learn the DSL, which may have a steeper learning curve compared to using a general-purpose language. Additionally, DSLs may be designed for a specific domain, thereby lacking the flexibility and versatility of general-purpose languages. If a project requires functionality or features outside the scope of the DSL, it may be challenging or impossible to accommodate those requirements.

In some cases, data may be obtained and/or stored electronically for input to a program or a machine learning model in different formats and/or different data structures (e.g., databases, blockchains, log files, cookies, or another data structure). A device may perform multiple queries, or other information retrieval techniques, to unrelated data structures to obtain data relevant to a particular task or computational operation. Moreover, each data structure may employ a particular schema and/or use particular data formatting conventions for data storage. Thus, the data may be incompatible and difficult to integrate into machine-usable outputs for computational instructions or automation. This incompatibility may necessitate separate handling of the data using complex instructions and/or repetitive processing to achieve desired computational outcomes or automation outcomes, thereby expending significant computing resources (e.g., processor resources and/or memory resources) and causing significant delays. The use of DSLs for machine learning models may increase the negative impact of these problems because only programmers trained in the DSL may be capable of handling the data using complex instructions and/or the repetitive processing to achieve desired computational outcomes or automation outcomes, thereby limiting the scope of programmers who are capable of performing these operations. Further, the DSL may not be designed to incorporate or use data in a given (e.g., new) structure or format, thereby limiting the scope or type of data the is available for use with applications or programs that use the DSL.

Some implementations described herein enable machine learning based updates of DSL parameters. In some implementations, the DSL parameters may be associated with a machine learning model, an application, or a program that identifies attributes of an entity from raw data (e.g., transaction data). A device may obtain an input in a natural language format. For example, the input may include audio data (e.g., that is associated with one or more spoken words) and/or text data indicating information in the natural language format. The device may analyze the input to identify one or more words or phrases from the input. For example, the device may perform a speech-to-text operation to convert audio data into text data. The device may parse the text data to identify the one or more words or phrases. The device may detect one or more keywords, from the one or more words or phrases, indicative of a domain or purpose associated with the DSL. For example, the device may detect keywords indicative of an entity and/or an attribute associated with an entity. The device may provide, to a machine learning model, an indication of the one or more keywords, the entity, the attribute, and/or the one or more words or phrases. The device may obtain, from the machine learning model, an output that indicates one or more DSL parameters that are to be updated.

For example, the machine learning model may be trained to identify and/or determine DSL updates based on natural language text or conversations. As an example, the input may be associated with recordings of customer service calls or discussions between team members that are associated with updates to attributes and/or information associated with an entity. The machine learning model may be enabled to identify one or more parameters and/or information to be updated associated with a DSL that is used for programming a machine learning model and/or other program that identifies entity attributes from raw data. As a result, the machine learning model and/or other program may be updated (e.g., via DSL instructions or parameters) based on the natural language text or conversations (e.g., without requiring the natural language text or conversations to be reviewed or analyzed by a programmer trained to understand or program using the DSL). This significantly increases the amount of data available to update the machine learning model and/or other program and reduces the amount of time associated with updating the machine learning model and/or other program.

As a result, the machine learning model (e.g., that predicts or recommends DSL parameters to be updated based on natural language speech or text) enables the device to perform operations based on otherwise incompatible data (e.g., natural language data versus data in the DSL format) while conserving computing resources and reducing delays that would otherwise result from separate handling of the data using complex instructions and/or repetitive processing. This improves an output of the machine learning model and/or program (e.g., that is programed using the DSL) because the amount of data available to update the machine learning model and/or program is significantly increased. Moreover, the amount of time between obtaining an input indicating an update associated with the machine learning model and/or program and the update being implemented via the DSL is significantly decreased. Further, an output of the machine learning model may convey data from the multiple unrelated databases, formats, and/or sources in a smaller user interface or in a lesser number of user interfaces than otherwise would have been used to individually present data from the multiple unrelated databases, formats, and/or sources (e.g., the machine learning model may enables updates to DSL parameters that are based on inputs from multiple unrelated databases, formats, and/or sources to be presented in a unified and/or a single user interface). In this way, the use of computing resources and network resources is reduced in connection with serving, generating, and/or displaying the updates to DSL parameters.

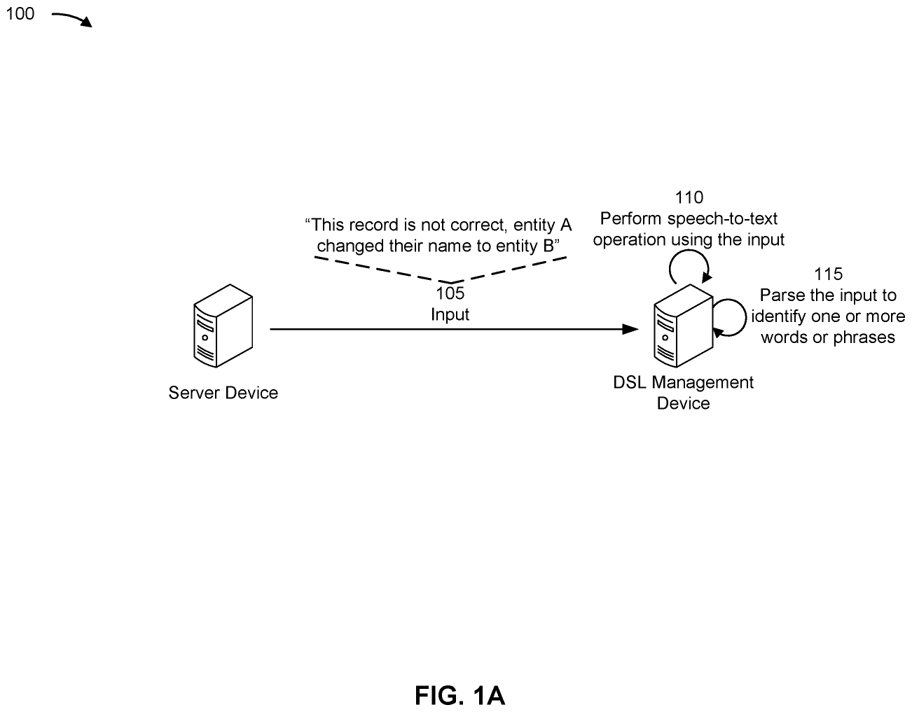

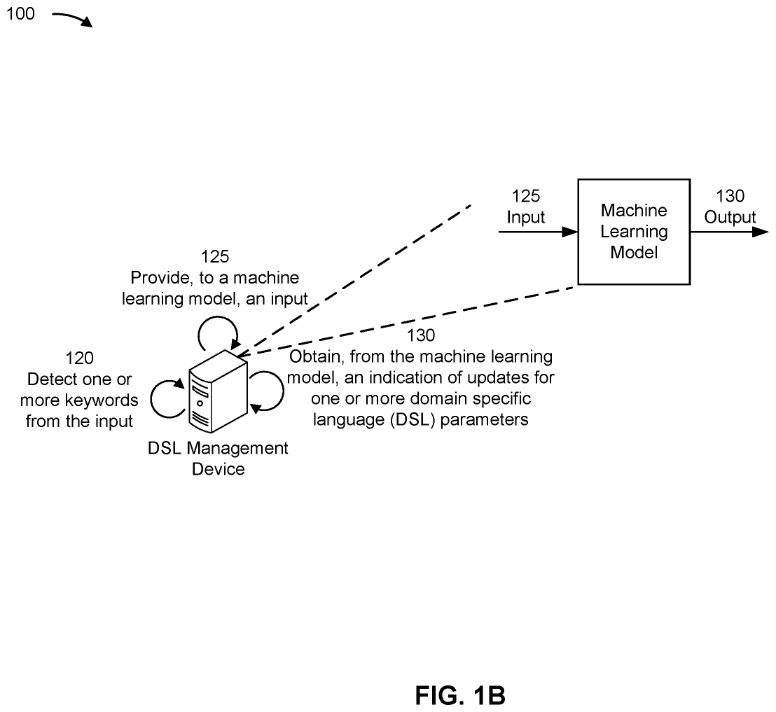

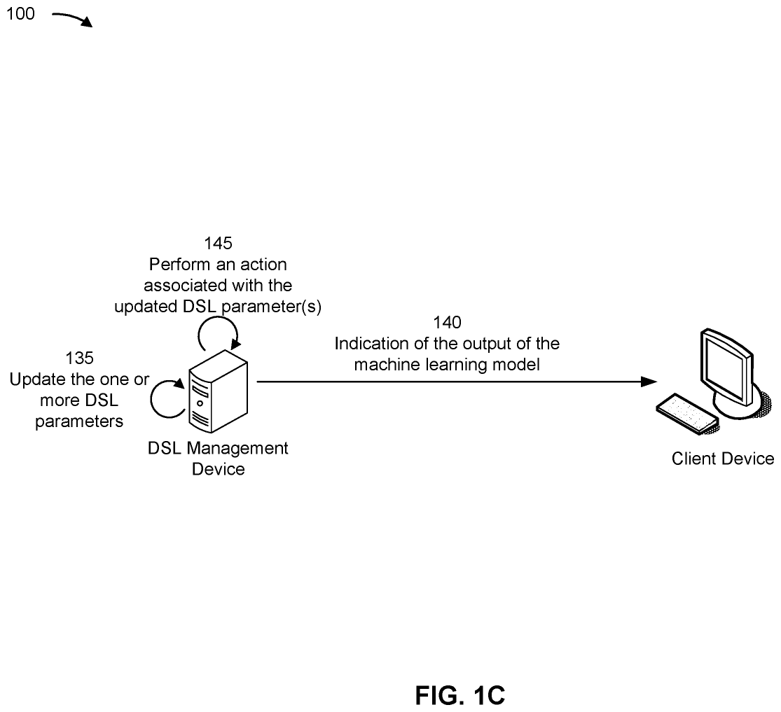

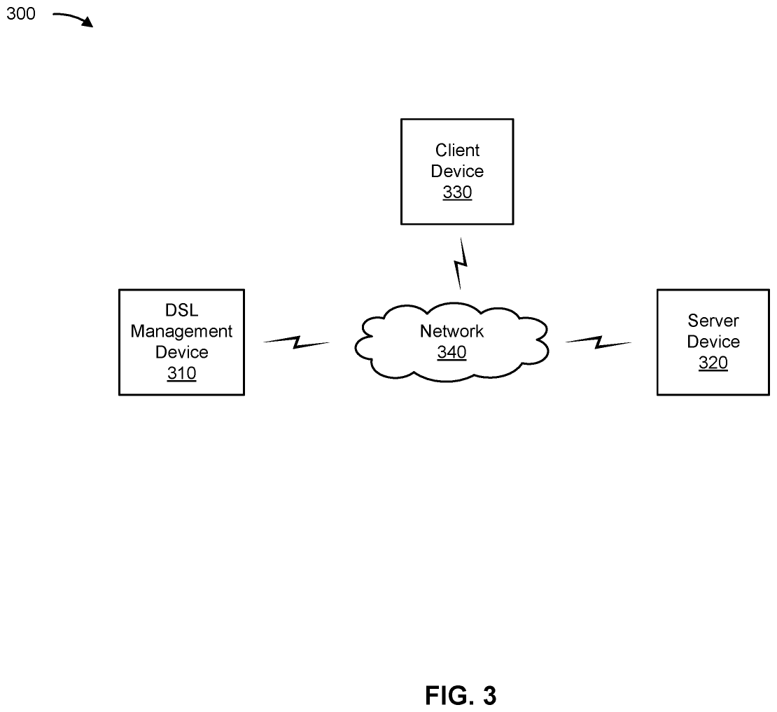

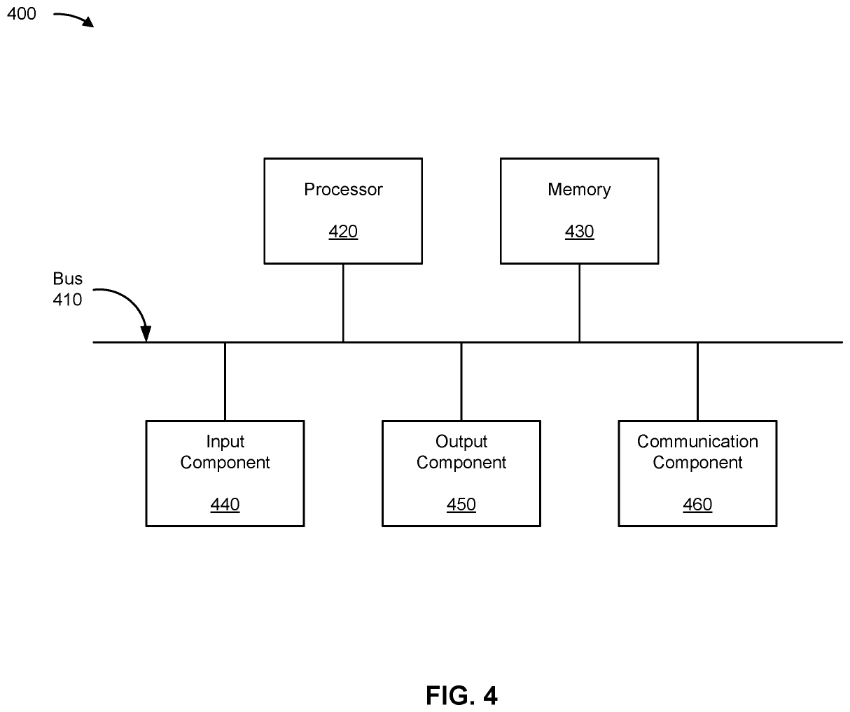

FIGS. 1A-1C are diagrams of an example 100 associated with machine learning based updates of DSL parameters. As shown in FIGS. 1A-1C, example 100 includes a DSL management device, a server device, and a client device. These devices are described in more detail in connection with FIGS. 3 and 4.

The DSL management device may be associated with updating and/or managing information associated with a DSL. The DSL may be associated with a machine learning model, a program, and/or an application that is associated with a domain or task. As described herein, the domain or task may be determining an entity (or brand) and/or determining attributes associated with the entity (or brand) from raw data (e.g., from transaction data). However, this domain or task is provided as an example and the operations or techniques described herein may be similarly applied for updating DSL parameters or information for a DSL associated with other domains or tasks.

As shown in FIG. 1A, and by reference number 105, the DSL management device may receive or obtain, from the server device, an indication of an input. The input may be in a natural language format. A natural language format may refer to a way of representing or structuring information using natural language, which is the language humans use for communication. Unlike structured formats such as programming languages or database schemas, natural language formats may make information more accessible and understandable to humans, without the need for specialized knowledge or technical skills. For example, the input may indicate information associated with a domain or task of the DSL. As an example, the input may indicate information associated with one or more attributes of an entity.

For example, as shown in FIG. 1A, the input may be “This record is not correct, entity A changed their name to entity B.” In this example, a user may be providing the input in response to a record of an account indication that a transaction or other action is associated with a name or brand of “entity A.” However, as indicated by the input, the brand name of entity A may have changed to entity B. In other words, the machine learning model, program, or application that uses the DSL may have identified the brand name associated with the transaction or other action correctly using the information or DSL parameters as currently stored or programmed, but the information of DSL parameters may be incorrect and/or out of date. The input may be indicative of an incorrect DSL parameter or other information programmed via the DSL for the machine learning model, program, or application that is associated with determining entity names or other attributes for records based on respective transaction data associated with the records.

The input may include audio data and/or text data. For example, the DSL management device may obtain audio data (e.g., voice data) indicating information associated with one or more attributes associated with an entity. The audio data may be a voice recording, a call recording, a meeting recording, and/or another type of audio data. For example, the audio data may be a recording of a call associated with a call center (e.g., where a user calls the call center to speak with an agent about an issue or problem). For example, the user may call the call center regarding an issue with an application that obtains information from the machine learning model, program, or application that uses the DSL. The DSL management device (or another device, such as a server device associated with the call center) may flag or otherwise indicate that a recording of the call is associated with the DSL and/or associated with a problem with the machine learning model, program, or application that uses the DSL. This may enable the DSL management device to obtain more relevant audio data and/or conserve computing resources that would have otherwise been used to process and/or analyze all audio data associated with the call center. As another example, the audio data may be a recording of employees of an institution associated with the DSL management device (e.g., discussing updates to the entity and/or attributes of the entity).

As another example, the input may include text data. For example, a user (or employee) may input text to a system, such as a chatbot. The text may indicate an issue with the application that obtains information from the machine learning model, program, or application that uses the DSL. The DSL management device (or another device, such as a server device associated with the chatbot) may flag or otherwise indicate that the text data associated with a chat is associated with the DSL and/or associated with a problem with the machine learning model, program, or application that uses the DSL, in a similar manner as described above.

In some implementations, the DSL management device may provide a user interface for inputting updates to the DSL in a natural language format. The DSL management device may provide, to the client device, the user interface to be displayed via the client device. For example, the user interface may include an input option associated with providing the input. A user (or employee) may interact with the input option to provide the input. For example, the user (or employee) may select the input option and provide the input to the client device (e.g., by inputting text, such as via a keyboard, or by speaking the input to a microphone or other audio recorder of the client device). In such examples, the DSL management device may obtain the input via the client device.

In some implementations, as shown by reference number 110, the DSL management device may perform a speech-to-text operation using the input. For example, the DSL management device may perform the speech-to-text operation based on, or in response to, the input including audio data. The speech-to-text operation may be associated with performing speech-to-text translation (sometimes referred to as voice-to-text translation, audio-to-text translation, speech recognition, automatic speech recognition, and/or computer speech recognition) to convert or translate the audio data into text data. For example, the DSL management device may translate spoken words in the audio data into text.

For example, the DSL management device may perform an audio-to-text operation to translate or convert the audio input into text data. In some implementations, the DSL management device may provide the audio input to a machine learning model (e.g., a speech recognition model or another machine learning model that is trained to convert audio into text). For example, the machine learning model may be deployed using cloud computing resources (e.g., the machine learning model may be deployed in a cloud computing environment). The DSL management device may provide the audio data to the machine learning model (e.g., via the cloud computing environment) and may obtain the text data from the machine learning model (e.g., via the cloud computing environment). In some implementations, the DSL management device may provide the audio input to another device, such as a server device. The DSL management device may obtain, from the other device, the text data (e.g., where the other device performs the speech-to-text operation).

For example, the speech-to-text operation may include pre-processing the audio input to remove background noise and/or to enhance a signal associated with the words of the audio data, such as by filtering, normalization, and/or feature extraction, among other examples. In some implementations, the speech-to-text operation may include transforming an audio waveform (e.g., associated with the audio input) into a sequence of numerical features that can be used as an input to the machine learning model. The machine learning model may predict a probability of each word in the text data based on the context of the surrounding words. For example, the machine learning model may search through a set of possible word sequences to find the most likely transcription based on the audio input and a language model (e.g., an acoustic model that may be used to map the input audio features to a sequence of phonemes, which may be a unit of sound that can distinguish one word from another in a particular language). The DSL management device may use the text data (e.g., that is obtained via performing the speech-to-text operation) to identify DSL parameters to be updated in response to information indicated by the input, as described in more detail elsewhere herein.

The DSL management device may analyze the input to identify one or more words or phrases from the input (e.g., from text data indicated from the input or translated from audio data). For example, as shown by reference number 115, the DSL management device may parse the input (e.g., the text data) to identify one or more words or phrases. For example, the DSL management device may perform a natural language processing (NLP) operation to identify one or more words or phrases in the text data. For example, the DSL management device may tokenize the text data into units for analysis. The DSL management device may identify boundaries between sentences, such as periods, question marks, exclamation points, or other indicators to determine the beginning and end of each sentence. The DSL management device may assign a part-of-speech tag to each token associated with the text data (e.g., where a part-of-speech tag indicates a grammatical category of a word, such as a noun, verb, adjective, or adverb). In some implementations, the DSL management device may perform phrase chunking or shallow parsing to group together words that form meaningful units, such as noun phrases or verb phrases. By identifying these phrases, the DSL management device may gain a better understanding of the syntactic structure of the text.

In some implementations, the DSL management device may perform a named entity recognition (NER) operation associated with the text data. For example, the DSL management device may perform NER to identify and categorize named entities within the text. Named entities can include people's names, organizations, locations, dates, or other specific types of information. NER may help the DSL management device to extract relevant entities, which can be useful for information retrieval or analysis, as described in more detail elsewhere herein. The DSL management device may perform dependency parsing to analyze the grammatical relationships between words in the text data. Dependency parsing may enable the DSL management device to establish links or dependencies between words, identifying which words are connected to each other and how they relate in terms of subject, object, modifier, or other roles. Dependency parsing may enable the DSL management device to obtain a deeper understanding of the syntactic structure and meaning of the text data (e.g., of the input).

As shown in FIG. 1B, and by reference number 120, the DSL management may detect one or more keywords from the input (e.g., from the one or more words or phrases obtained via parsing the text data). For example, the one or more keywords may be associated with a domain or task that is associated with the DSL. The one or more keywords may be DSL keywords indicative of one or more brand parameters associated with the entity. For example, the DSL management device may detect one or more keywords, from the one or more words or phrases included in the text data, indicative of an entity and/or an attribute of an entity.

The attributes or parameters associated with the entity (e.g., brand parameters) may include a brand name (e.g., an entity name), one or more uniform resource locator (URL) addresses (e.g., of a website associated with the entity or brand), one or more location addresses (e.g., addresses of physical locations associated with the entity or brand), one or more phone numbers, one or more email addresses, a merchant category code associated with the entity or brand, one or more national parameters (e.g., where a national parameter is a brand parameter associated with a national or corporate entity of the brand, such as a URL of a corporate website or phone number), one or more location-specific parameters (e.g., where a location-specific parameter is a brand parameter of a specific location or branch of the entity or brand, such as a URL of a branch website, or a phone number associated with a specific location or brand), and/or a relationship parameter indicating a relationship between two or more brand parameters, among other examples.

In some implementations, an attribute or parameter associated with the entity (e.g., brand parameters) may include an indication of a relationship between the entity and one or more other entities. For example, the relationship may be a parent-subsidiary relationship (e.g., where one entity (e.g., the parent entity) owns a controlling interest in another entity (e.g., the subsidiary entity)), a joint venture relationship (e.g., where two or more entities are pursuing a joint venture), a strategic alliance relationship, a supplier-customer relationship (e.g., where one entity (e.g., the supplier entity) provides goods or services to another entity (e.g., the customer entity)), a distribution relationship (e.g., where one entity is a distributor for another entity), a franchise relationship (e.g., where one entity (e.g., the franchisor entity) grants another entity (e.g., the franchisee entity) a right to operate a business using a brand of the franchisor entity), and/or a licensing relationship (e.g., where one entity (e.g., the licensor entity) grants another entity (e.g., the licensee entity) a right to operate a business using intellectual property or other property of the licensor entity), among other examples. The relationships between different entities may provide valuable information for determining an entity (or brand) and/or attributes associated with the entity (or brand) from raw data (e.g., from transaction data) because the entity or brand name a user is expecting to be associated with a transaction may be an entity or brand that has a relationship with the entity that is actually associated with the transaction.

The DSL management device may search the one or more words or phrases included in the text data associated with the input for the keywords. For example, the one or more keywords may be based on NER associated with the text data. The one or more keywords may include named entities identified based on performing NER associated with the text data. As an example, from the input of “This record is not correct, entity A changed their name to entity B,” a keyword may include entity A and/or entity B. As another example, a keyword may be associated with, or indicative of, an update or a change to be made to a given DSL parameter. For example, one or more DSL parameters (e.g., one or more instructions or code written using the DSL) may be associated with identifying a name of an entity (e.g., an entity name or a brand name). In such examples, the phrase “changed their name” may be a keyword associated with changing or updating the one or more DSL parameters associated with identifying a name of an entity. As another example, a keyword may be associated with, or indicative of, an update or change needing to be made to the machine learning model, program, or application that is associated with the DSL. For example, the phrase “this record is not correct” and/or the phrase “not correct” may be a keyword associated with an update or change needing to be made to the machine learning model, program, or application that is associated with the DSL.

Detecting the one or more keywords may enable the DSL management device to determine that the input is to be provided to a machine learning model for processing to identify recommended updates to DSL parameter(s). This may conserve computing resources that would have otherwise been associated with the machine learning model processing and/or analyzing all inputs. Additionally, or alternatively, detecting the one or more keywords may enable the DSL management device to provide more relevant information and/or information indicated by the one or more keywords (such as a specific attribute or parameter of an entity that is associated with the input) to the machine learning model. This may improve the accuracy of the output of the machine learning model may providing additional information and/or more relevant information as an input to the machine learning model.

As shown by reference number 125, the DSL management device may provide, to a machine learning model, an input (e.g., a machine learning input). The machine learning input to the machine learning model may include the text data associated with the user input (e.g., the user input being the input obtained by the DSL management device as described in connection with FIG. 1A and reference number 105). For example, the machine learning input may include the one or more words or phrases identified from the text data of the user input. Additionally, or alternatively, the machine learning input may include the one or more keywords detected from the one or more words or phrases identified from the text data of the user input. In some implementations, the machine learning input may include an indication of the entity or brand associated with the user input (e.g., identified via NER or another NLP operation).

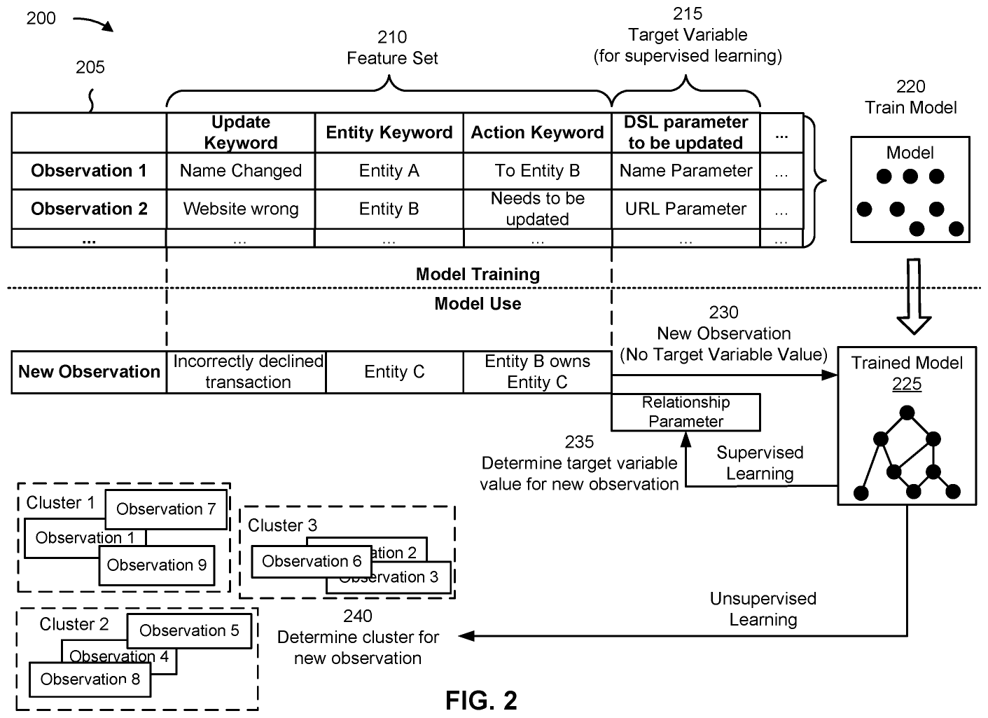

The machine learning model may be trained to identify DSL parameters (e.g., instructions or code written via the DSL) to be updated based on natural language inputs. For example, the machine learning model may be trained to identify information to be updated (e.g., a change to be made associated with attributes of an entity and/or a brand) and specific DSL parameter(s) or portions of DSL code to be updated. The training and operation of the machine learning model is described in more detail in connection with FIG. 2.

In some implementations, the machine learning input may include an indication of one or more contextual inputs associated with the user input. A contextual input may include information indicative of a context or purpose associated with the user input. For example, the contextual input may include location information (e.g., associated with a user or device that provides the user input to the DSL management device or to the server device), a user identifier associated with the user input, an account identifier of an account associated with the user, an account record of a user associated with the user input, and/or an image associated with the entity (e.g., an image of a logo), among other examples. The one or more contextual inputs may provide additional useful data for the machine learning model to identify and/or determine one or more updates to be made in response to the user input. Therefore, providing the one or more contextual inputs may improve the accuracy and/or usefulness of the output of the machine learning model.

The DSL management device may obtain the one or more contextual inputs from the server device. Additionally, or alternatively, the DSL management device may determine the one or more contextual inputs. For example, the DSL management device may determine the one or more contextual inputs based on device information of a device associated with the user input. For example, the device information may include a device identifier. The device identifier may be mapped to a user and/or an account. For example, the user may register the device identifier as being associated with an account (e.g., by logging into an application executing on the device using credentials associated with the account). Therefore, the DSL management device may determine the user, the account, a record (e.g., a transaction record), and/or another contextual input associated with the user input based on the device information. Obtaining an indication of the account and/or record may enable the DSL management device to provide the machine learning model with the raw data (e.g., transaction data) that was used to generate the entity information or attributes that are indicated as needing updating by the user input. This may reduce a complexity associated with the machine learning model determining the one or more DSL parameters to be updated and/or the update(s) to be made because the machine learning model may obtain the actual data that was used to generate the information that was indicated as being incorrect or needing to be updated.

In some implementations, the device information may include location information associated with the device at, or around, the time that the user input was provided. The location information may indicate a specific location, branch, or entity associated with the user input. For example, an entity (or brand) may be associated with multiple locations or branches located at different physical locations. The location information may provide an indication as to which location or branch is associated with the user input (e.g., because there is a higher likelihood that a user is speaking about a location or branch that is geographically closer to the location of the user).

As shown by reference number 130, the DSL management device may obtain an output from the machine learning model. The output may indicate one or more updates for one or more DSL parameters. For example, the output may indicate updates for respective DSL parameters based on the user input. In some implementations, the machine learning model may output recommendations of updates to respective DSL parameters based on the user input. For example, the one or more DSL parameters may include code, instructions, files, databases, entries in a database, and/or other information that are written or formatted using the DSL that are recommended to be updated or changed in response to the user input.

The one or more DSL parameters may include an entity relationship parameter indicative of a relationship between the entity and one or more other entities. In some implementations, the one or more DSL parameters may include DSL parameters associated with metadata that is associated with the entity. The metadata may include one or more URLs, phone numbers, email addresses, addresses, images (e.g., logo images), and/or other information to be updated (e.g., using a format or code associated with the DSL) for an entity.

As shown in FIG. 1C, the DSL management device may perform one or more actions to cause the one or more DSL parameters to be updated. For example, as shown by reference number 135, the DSL management device may update the one or more DSL parameters based on, or in response to, the output of the machine learning model. For example, the output of the machine learning model may indicate the update and/or may indicate code or instructions (e.g., in the DSL and/or in a format associated with the DSL) to be used to update the one or more DSL parameters. The DSL management device may be configured to automatically update the one or more DSL parameters based on, or in response to, the output of the machine learning model (e.g., using the update, code, or instructions indicated by the output of the machine learning model).

Additionally, or alternatively, as shown by reference number 140, the DSL management device may transmit or provide, and the client device may receive or obtain, an indication of the output of the machine learning model. For example, the DSL management device may provide, to the client device, an indication of the recommended update(s) to one or more DSL parameters that are output by the machine learning model. This may enable a user (e.g., an employee of the institution associated with the DSL management device) to review the recommended updates and determine whether to implement the recommendations of the machine learning model. In some implementations, the client device may obtain, via the user, an indication to update the one or more DSL parameters (e.g., based on providing the one or more DSL parameters for display via the client device). In such examples, the DSL management device may obtain, via a user input (e.g., to the client device) and based on providing the indication of the output, an indication of the one or more updated DSL parameters.

In some implementations, the DSL management device may provide, for display via the client device, a user interface associated with recommended DSL parameter updates. The user interface may provide indications for all updates to DSL parameters (e.g., for a machine learning model, program, or application that uses the DSL) in a unified manner. For example, a user may be enabled to view and/or review all recommended updates to DSL parameters via the user interface. The user interface may provide, for display, an indication of the contextual input(s) associated with a recommended update to DSL parameters (e.g., the contextual input(s) that are associated with a user input that caused the machine learning model to recommend a given update). This conserves computing resources by reducing an amount of navigation to different pages, programs, or applications, that would otherwise be required to identify, view, investigate, and/or review relevant content associated with the update(s) to DSL parameters. Furthermore, the user interface makes data easier to access by providing recommended updates and other contextual information viewable via a single user interface, thereby improving a user experience, and improving the ability of a user to access information (e.g., by enabling the user to via recommended DSL parameter updates and contextual information via the user interface). In other words, the user may quickly locate content of interest associated with investigating or reviewing a recommended update to a DSL parameter without navigating away from the user interface and without following numerous links from the user interface. In this way, computing resources and/or network resources may be conserved by reducing an amount of navigation performed by the user.

As shown by reference number 145, the DSL management device may perform an action associated with the one or more updated DSL parameters. In some implementations, the action may include updating display information for one or more records of respective accounts using the one or more updated DSL parameters. For example, the DSL management device may cause display information (e.g., information that is display in connection with a record (e.g., transaction record) of an account) to be updated based on the one or more updated DSL parameters. This enables the DSL management device to proactively update the display information based on, or in response to, the one or more updated DSL parameters.

In some implementations, the action may include determining an entity and/or entity attributes using the one or more updated DSL parameters. For example, the DSL management device may provide, to an application or another machine learning model (e.g., that uses the DSL), an indication of the one or more updated DSL parameters. The DSL management device may provide, to the application or the other machine learning model, transaction data. The DSL management device may obtain, from the application or the other machine learning model, an indication of attributes of one or more entities associated with the transaction data based on providing the indication of the one or more updated DSL parameters. For example, the DSL management device (or another device) may cause display information indicating the attributes of one or more entities associated with the transaction data to be displayed in connection with a record associated with the transaction data.

In some implementations, the action may include updating an entity relationship graph to indicate a relationship between the entity and one or more other entities based on the entity relationship parameter. For example, as described elsewhere herein, the DSL management device may obtain an indication of a relationship between two or more entities. The DSL management device may update a graph (e.g., associated with an entity) that provides a visual depiction of relationships between the entity and one or more other entities to include the detected or determined relationship (e.g., that is detected or determined based on the user input). In some implementations, the DSL management device may provide the graph for display (e.g., via the client device) to enable users to quickly and easily identify relationships associated with the entity.

In some implementations, the action may include updating user preference data for a user associated with the user input. For example, the DSL management device may analyze the user input (e.g., may analyze inflections or other indications in audio data and/or may analyze a semantic meaning of text data) to determine one or more user preferences for an entity indicated by the user input. As an example, the DSL management device may determine that the user input indicates negative feelings or positive feelings associated with the entity. The DSL management device may update preferences associated with the user accordingly.

As indicated above, FIGS. 1A-1C are provided as an example. Other examples may differ from what is described with regard to FIGS. 1A-1C.

FIG. 2 is a diagram illustrating an example 200 of training and using a machine learning model in connection with machine learning based updates of DSL parameters. The machine learning model training and usage described herein may be performed using a machine learning system. The machine learning system may include or may be included in a computing device, a server, a cloud computing environment, or the like, such as the DSL management device described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the server device and/or the DSL management device, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the server device and/or the DSL management device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of an update keyword (e.g., indicating a type of update to be performed), a second feature of an entity keyword (e.g., indicating an entity associated with a user input), a third feature of an action keyword (e.g., indicating the update to be performed), and so on. As shown, for a first observation, the first feature may have a value of “Name Changed” (e.g., indicating that the user input is associated with changing a name of an entity or brand), the second feature may have a value of “Entity A,” the third feature may have a value of “To Entity B” (e.g., indicating that the update to one or more DSL parameters is to change the name of Entity A to Entity B), and so on. These features and feature values are provided as examples, and may differ in other examples. For example, the feature set may include one or more of the following features: contextual information (e.g., location, address, transaction record, user identifier, device identifier, account identifier, and/or other contextual information), transaction data (or other raw data) associated with the set of observations (e.g., that was used to generate an output that prompted a user input), and/or other features.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is “DSL parameter to be updated”, which has a value of “Name Parameter” for the first observation.

The feature set and target variable described above are provided as examples, and other examples may differ from what is described above. For example, for DSLs associated with other domains or tasks, the feature set may include features associated with a domain or task associated with the DSL.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on data that is used to previously updated DSL parameters for the DSL. For example, a device (e.g., the server device) may obtain an indication of one or more updates that were previously performed for DSL parameters of the DSL. The device may obtain information that was reviewed in connection with (e.g., by a programmer) and/or used to determine the updates to the DSL parameters. The device may obtain labels and/or tags for features included in the information to generate the training data.

As shown by reference number 230, the machine learning system may apply the trained machine learning model 225 to a new observation, such as by receiving a new observation and inputting the new observation to the trained machine learning model 225. As shown, the new observation may include a first feature of an update keyword, a second feature of an entity keyword, a third feature of an action keyword, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “Relationship parameter” for the target variable of “DSL parameter to be updated” for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, to update a DSL parameter corresponding to an entity relationship to indicate that Entity B owns Entity C. The first automated action may include, for example, automatically update the DSL parameter and/or to provide an indication of the first recommendation to another device, such as the client device.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first DSL parameter), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. For example, the recommendations associated with updates in the DSL may include code or instructions, in the DSL, to cause the update indicated by a user input to be implemented. The actions associated with updates in the DSL may include, for example, adding the updates in the DSL to a code base or database associated with the DSL.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include additional user inputs indicating whether correct determinations were made using the updated DSL parameter(s). As another example, the feedback information may include an indication of whether a recommendation (e.g., to update a given DSL parameter) was actually implemented (e.g., by a programmer).

In this way, the machine learning system may apply a rigorous and automated process to updating DSL parameters based on user inputs in a natural language format. The machine learning system may enable recognition and/or identification of tens, hundreds, thousands, or millions of features and/or feature values for tens, hundreds, thousands, or millions of observations, thereby increasing accuracy and consistency and reducing delay associated with updating DSL parameters based on user inputs in a natural language format relative to requiring computing resources to be allocated for tens, hundreds, or thousands of operators to manually update the DSL parameters based on user inputs using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a DSL management device 310, a server device 320, a client device 330, and a network 340. Devices of environment 300 may interconnect via wired connections, wireless connections, or a combination of wired and wireless connections.

The DSL management device 310 may include one or more devices capable of receiving, generating, storing, processing, providing, and/or routing information associated with machine learning based updates of DSL parameters, as described elsewhere herein. The DSL management device 310 may include a communication device and/or a computing device. For example, the DSL management device 310 may include a server, such as an application server, a client server, a web server, a database server, a host server, a proxy server, a virtual server (e.g., executing on computing hardware), or a server in a cloud computing system. In some implementations, the DSL management device 310 may include computing hardware used in a cloud computing environment.

The server device 320 may include one or more devices capable of receiving, generating, storing, processing, providing, and/or routing information associated with machine learning based updates of DSL parameters, as described elsewhere herein. The server device 320 may include a communication device and/or a computing device. For example, the server device 320 may include a server, such as an application server, a client server, a web server, a database server, a host server, a proxy server, a virtual server (e.g., executing on computing hardware), or a server in a cloud computing system. In some implementations, the server device 320 may include computing hardware used in a cloud computing environment.

The client device 330 may include one or more devices capable of receiving, generating, storing, processing, and/or providing information associated with machine learning based updates of DSL parameters, as described elsewhere herein. The client device 330 may include a communication device and/or a computing device. For example, the client device 330 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with machine learning based updates of DSL parameters. The device 400 may correspond to the DSL management device 310, the server device 320, and/or the client device 330. In some implementations, the DSL management device 310, the server device 320, and/or the client device 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

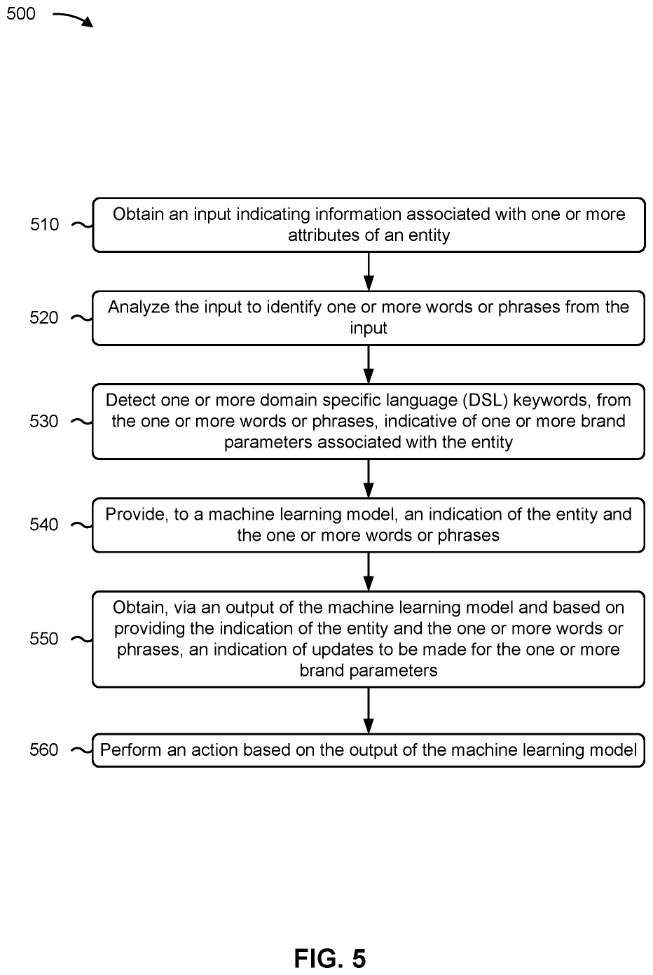

FIG. 5 is a flowchart of an example process 500 associated with machine learning based updates of DSL parameters. In some implementations, one or more process blocks of FIG. 5 may be performed by the DSL management device 310. In some implementations, one or more process blocks of FIG. 5 may be performed by another device or a group of devices separate from or including the DSL management device 310, such as the server device 320 and/or the client device 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining an input indicating information associated with one or more attributes of an entity (block 510). For example, the DSL management device 310 (e.g., using processor 420 and/or memory 430) may obtain an input indicating information associated with one or more attributes of an entity, as described above in connection with reference number 105 of FIG. 1A. As an example, the input may include audio data and/or text data that indicates an update to be made to the one or more attributes of the entity.

As further shown in FIG. 5, process 500 may include analyzing the input to identify one or more words or phrases from the input (block 520). For example, the DSL management device 310 (e.g., using processor 420 and/or memory 430) may analyze the input to identify one or more words or phrases from the input, as described above in connection with reference number 115 of FIG. 1A. As an example, the DSL management device 310 may parse the input (e.g., text data of the input) to identify the one or more words or phrases (e.g., using an NLP operation and/or an NER operation).

As further shown in FIG. 5, process 500 may include detecting one or more DSL keywords, from the one or more words or phrases, indicative of one or more brand parameters associated with the entity (block 530). For example, the DSL management device 310 (e.g., using processor 420 and/or memory 430) may detect one or more DSL keywords, from the one or more words or phrases, indicative of one or more brand parameters associated with the entity, as described above in connection with reference number 120 of FIG. 1B. As an example, the one or more DSL keywords may be indicative of a domain or task associated with the DSL. For example, the one or more DSL keywords may indicate information associated with the one or more attributes of the entity. In some implementations, the DSL management device 310 may determine that the input should be provided to a machine learning model based on detecting the one or more keywords.

As further shown in FIG. 5, process 500 may include providing, to a machine learning model, an indication of the entity and the one or more words or phrases (block 540). For example, the DSL management device 310 (e.g., using processor 420 and/or memory 430) may provide, to a machine learning model, an indication of the entity and the one or more words or phrases, as described above in connection with reference number 125 of FIG. 1B. As an example, the DSL management device 310 may provide an input to the machine learning model that includes an indication of the entity, the one or more words or phrases, and/or the one or more keywords.

As further shown in FIG. 5, process 500 may include obtaining, via an output of the machine learning model and based on providing the indication of the entity and the one or more words or phrases, an indication of updates to be made for the one or more brand parameters (block 550). For example, the DSL management device 310 (e.g., using processor 420 and/or memory 430) may obtain, via an output of the machine learning model and based on providing the indication of the entity and the one or more words or phrases, an indication of updates to be made for the one or more brand parameters, as described above in connection with reference number 130 of FIG. 1B. As an example, the output may indicate one or more updates for respective DSL parameters. The DSL parameters may include a parameter, code, an instruction, a file, a database, an entry in a database, or other information that is written or formatted using the DSL.

As further shown in FIG. 5, process 500 may include performing an action based on the output of the machine learning model (block 560). For example, the DSL management device 310 (e.g., using processor 420 and/or memory 430) may perform an action based on the output of the machine learning model, as described above in connection with reference numbers 135, 140, and/or 145 of FIG. 1C. As an example, the DSL management device 310 may cause an indication of the update(s) to be displayed (e.g., via a user interface), and/or may cause the one or more DSL parameters to be updated in accordance with the output of the machine learning model, among other examples.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for machine learning based updates of domain specific language (DSL) parameters, the system comprising:
one or more memories; and
one or more processors, communicatively coupled to the one or more memories, configured to:
obtain audio data indicating information associated with one or more attributes associated with an entity;
analyze the audio data to identify one or more words or phrases from the audio data;
detect one or more keywords, from the one or more words or phrases, indicative of the entity;
provide, to a machine learning model, an indication of the entity and the one or more words or phrases;
obtain, from the machine learning model and based on providing the indication of the entity and the one or more words or phrases, an indication of one or more DSL parameters that are to be updated for the entity,
wherein the one or more DSL parameters are associated with the one or more attributes; and
update, based on an output of the machine learning model, the one or more DSL parameters to obtain one or more updated DSL parameters.

2. The system of claim 1, wherein the one or more DSL parameters are associated with an application or another machine learning model that is capable of determining attributes of entities from raw data.

3. The system of claim 1, wherein the one or more processors are further configured to:
provide, to an application or another machine learning model, an indication of the one or more updated DSL parameters;
provide, to the application or the other machine learning model, transaction data; and
obtain, from the application or the other machine learning model, an indication of attributes of one or more entities associated with the transaction data based on providing the indication of the one or more updated DSL parameters.

4. The system of claim 1, wherein the one or more processors, to provide the indication of the entity and the one or more words or phrases, are configured to:
provide, to the machine learning model, an indication of one or more contextual inputs associated with the audio data.

5. The system of claim 4, wherein the one or more contextual inputs include at least one of:
location information,
a user identifier associated with the audio data,
an account record of a user associated with the audio data, or
an image associated with the entity.

6. The system of claim 1, wherein the one or more processors, to update the one or more DSL parameters, are configured to:
provide, to a device, an indication of the output of the machine learning model; and
obtain, via a user input and based on providing the indication of the output, an indication of the one or more updated DSL parameters.

7. The system of claim 1, wherein the one or more DSL parameters include an entity relationship parameter indicative of a relationship between the entity and one or more other entities.

8. The system of claim 1, wherein the one or more DSL parameters include metadata associated with the entity.

9. A method of machine learning based updates of brand parameters, comprising:
obtaining, by a device, an input indicating information associated with one or more attributes of an entity;
analyzing, by the device, the input to identify one or more words or phrases from the input;
detecting, by the device, one or more domain specific language (DSL) keywords, from the one or more words or phrases, indicative of one or more brand parameters associated with the entity;
providing, by the device and to a machine learning model, an indication of the entity and the one or more words or phrases;
obtaining, by the device and via an output of the machine learning model and based on providing the indication of the entity and the one or more words or phrases, an indication of updates to be made for the one or more brand parameters; and
performing, by the device, an action based on the output of the machine learning model.

10. The method of claim 9, wherein the input includes at least one of audio data or text data.

11. The method of claim 9, wherein performing the action comprises:
updating, in a database, the one or more brand parameters based on the output of the machine learning model.

12. The method of claim 9, wherein performing the action comprises:
providing, to another device, an indication of the updates to be made for the one or more brand parameters.

13. The method of claim 9, wherein the input includes voice data or text data that is indicative of the updates.

14. The method of claim 9, wherein the one or more brand parameters include an entity relationship parameter, and wherein performing the action comprises:
updating an entity relationship graph to indicate a relationship between the entity and one or more other entities based on the entity relationship parameter.

15. The method of claim 9, wherein the one or more brand parameters include at least one of:
a brand name,
one or more uniform resource locator addresses,
one or more location addresses,
one or more phone numbers,
one or more email addresses,
a merchant category code,
one or more national parameters,
one or more location-specific parameters, or
a relationship parameter indicating a relationship between two or more brand parameters.

16. A non-transitory computer-readable medium storing a set of instructions, the set of instructions comprising:
one or more instructions that, when executed by one or more processors of a device, cause the device to:
obtain audio data indicating information associated with one or more attributes associated with an entity;
analyze the audio data to identify one or more words or phrases from the audio data;
detect one or more keywords, from the one or more words or phrases, indicative of the entity;
provide, to a machine learning model, an indication of the entity and the one or more words or phrases;
obtain, from the machine learning model and based on providing the indication of the entity and the one or more words or phrases, an indication of one or more domain specific language (DSL) parameters that are to be updated for the entity; and
update, based on an output of the machine learning model, the one or more DSL parameters to obtain one or more updated DSL parameters.

17. The non-transitory computer-readable medium of claim 16, wherein the one or more DSL parameters are associated with determining attributes of entities from transaction data.

18. The non-transitory computer-readable medium of claim 16, wherein the one or more instructions further cause the device to:
provide, to another machine learning model that uses the one or more updated DSL parameters, transaction data; and
obtain, from the other machine learning model, an indication of attributes of one or more entities associated with the transaction data based on providing the indication of the one or more updated DSL parameters.

19. The non-transitory computer-readable medium of claim 16, wherein the one or more instructions, that cause the device to provide the indication of the entity and the one or more words or phrases, cause the device to:
provide, to the machine learning model, an indication of one or more contextual inputs associated with the audio data.

20. The non-transitory computer-readable medium of claim 16, wherein the one or more instructions, that cause the device to update the one or more DSL parameters, cause the device to:
provide, to another device, an indication of the output of the machine learning model; and
obtain, via a user input and based on providing the indication of the output, an indication of the one or more updated DSL parameters.
